(19) United States
(12) Patent Application Publication
(10) Pub. No.: US 2015/0029973 A1
(43) Pub. Date: Jan. 29, 2015

(54) Signalling Interfaces in Communications

(71) Applicants: Seppo Ilmari Vesterinen, Oulunsalo (FI); Matti Einari Laitila, Oulu (FI); Alexander Vesely, Feldbach (AT); Yang Liu, Beijing (CN); Yixue Lei, Beijing (CN)

(72) Inventors: Seppo Ilmari Vesterinen, Oulunsalo (FI); Matti Einari Laitila, Oulu (FI); Alexander Vesely, Feldbach (AT); Yang Liu, Beijing (CN); Yixue Lei, Beijing (CN)

(21) Appl. No.: 14/379,377

(22) PCT Filed: Feb. 21, 2012
(86) PCT No.: PCT/CN2012/071392

§ 371 Date: Aug. 18, 2014

(51) Int. Cl. H04W 28/08; H04W 88/06

(52) U.S. Cl. CPC H04W 28/085; H04W 88/06
USPC 370/329

(57) ABSTRACT

A method is disclosed, including supporting, in a communication apparatus (UE), a stand-alone operation mode for using, without a core network (EPC) involvement, bearer services provided by a local network (LTE-LAN). The method further includes supporting, in the communication apparatus (UE), flexible single radio/dual radio modes for offloading resources of a macro network (LTE) in order to use bearer services provided by the macro network (LTE) either in the single radio mode or in the dual radio mode, wherein said offloading is controlled by an associated macro network apparatus (eNB).

### FIELD OF THE INVENTION

The exemplary and non-limiting embodiments of this invention relate generally to wireless communications networks, and more particularly to managing signalling interfaces.

### BACKGROUND ART

The following description of background art may include insights, discoveries, understandings or disclosures, or associations together with dis-closures not known to the relevant art prior to the present invention but provided by the invention. Some such contributions of the invention may be specifically pointed out below, whereas other such contributions of the invention will be apparent from their context.

Along with the development of an LTE system, high-speed data service is one of the most important requirements. Especially for local area networks (LAN), higher data rate may be expected from a user's perspective. How to provide local service with high speed data rate has become a hot topic in 3GPP.

### SUMMARY

The following presents a simplified summary of the invention in order to pro-vide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

Various aspects of the invention comprise a method, apparatuses, and a computer program product as defined in the independent claims. Further embodiments of the invention are disclosed in the dependent claims.

An aspect of the invention relates to a method comprising supporting, in a communication apparatus, a stand-alone operation mode for using, without a core network involvement, bearer services provided by a local network; and supporting, in the communication apparatus, flexible single radio/dual radio modes for offloading resources of a macro network in order to use bearer services provided by the macro network either in the single radio mode or in the dual radio mode, wherein said offloading is controlled by an associated macro network apparatus.

A further aspect of the invention relates to an apparatus comprising at least one processor; and at least one memory including a computer program code, wherein the at least one memory and the computer program code are configured to, with the at least one processor, cause the apparatus to support a stand-alone operation mode for using, without a core network involvement, bearer services provided by a local network; and support flexible single radio/dual radio modes for offloading resources of a macro network in order to use bearer services provided by the macro network either in the single radio mode or in the dual radio mode, wherein said offloading is controlled by an associated macro network apparatus.

A still further aspect of the invention relates to an apparatus comprising at least one processor; and at least one memory including a computer program code, wherein the at least one memory and the computer program code are configured to, with the at least one processor, cause the apparatus to control offloading resources of a macro network in order to provide bearer services to a user terminal, the user terminal supporting a stand-alone operation mode for using, without a core network involvement, bearer services provided by a local network, and a flexible single radio/dual radio modes for offloading resources of the macro network in order to use bearer services provided by the macro network either in the single radio mode or in the dual radio mode.

A still further aspect of the invention relates to an apparatus comprising at feast one processor; and at least one memory including a computer program code, wherein the at least one memory and the computer program code are configured to, with the at least one processor, cause the apparatus to provide services of a local network to a user terminal, the user terminal supporting a stand-alone operation mode for using, without a core network involvement, bearer services provided by the focal network, and a flexible single radio/dual radio modes for offloading resources of a macro network in order to use bearer services provided by the macro network either in the single radio mode or in the dual radio mode, wherein said offloading is controlled by an associated macro network node.

A still further aspect of the invention relates to a computer program product comprising program code means adapted to perform any of the method steps when the program is run on a computer.

### BRIEF DESCRIPTION OF THE DRAWINGS

In the following the invention will be described in greater detail by means of exemplary embodiments with reference to the attached drawings, in which

FIG. 1 illustrates an LTE-LAN network architecture according to an exemplary embodiment;

FIG. 2 illustrates control interfaces in a dual radio mode according to an exemplary embodiment;

FIG. 3 illustrates control interfaces in a single radio mode according to an exemplary embodiment;

FIG. 4 illustrates a user plane protocol stack in a stand-alone operation mode according to an exemplary embodiment;

FIG. 5 illustrates a user plane protocol stack in a dual radio mode according to an exemplary embodiment;

FIG. 6 illustrates a control plane protocol stack in a dual radio mode according to an exemplary embodiment;

FIG. 7 illustrates a control plane protocol stack in a single radio mode according to an exemplary embodiment;

FIG. 8 shows a simplified block diagram illustrating exemplary system architecture;

FIG. 9 shows a simplified block diagram illustrating exemplary apparatuses;

FIG. 10 shows a messaging diagram illustrating exemplary signalling according to an embodiment of the invention;

FIG. 11 shows a schematic diagram of a flow chart according to an exemplary embodiment of the invention;

FIG. 12 shows a schematic diagram of a flow chart according to an exemplary embodiment of the invention;

FIG. 13 shows a schematic diagram of a flow chart according to an exemplary embodiment of the invention.

### DETAILED DESCRIPTION OF SOME EMBODIMENTS

Local area evolution (LAE) aims to design a local area system providing high performance on peak data rate, cell capacity, QoS guarantee, interference management, etc. Low cost and high energy efficiency are also expected for the LAE system. In the LAE system, a support node (SN) concept is introduced. The support node (SN) refers to a network element located in a core network, providing some support/control/maintenance functionalities to the LAE system. A base station (BS) is located in the RAN side which provides the local area network, just like HeNB in the LTE system. UE maintains two connections with macro-eNB and LAE-BS, which are called “dual radio connections”. A macro network connection is more stable and more carefully managed so that UE does not easily lose its connection, while a LAE connection is there more like for providing high speed data service in the local area.

LTE-LAN may be considered to compete with Wi-Fi technique. LTE-LAN is basically assumed to be based on LTE technology but is more focused on certain local area use cases and scenarios, and it has much similarity with the LAE concept. LTE-LAN is expected to provide high performance service for users, with low cost, and is expected to become a competitor to Wi-Fi. Since LAE and LTE-LAN both have the same requirements and features, the achievements on LAE may be transferred to the development of LTE-LAN.

A promising local area concept is an architecture based on the LTE-LAN and LAE concept which may also be referred to as a LTE-Hi concept. Basic assumptions in this concept include: 1) dual band operation, where local and wide area accesses are using different radios; and 2) autonomous (local area) operation to a mobile core network enabling LTE-LAN local access services deployment and operation either by a mobile operator or a local access network operator (third party), where the usage of LTE-LAN network locally supported services may be kept transparent to the core network for simplicity and for lightening signalling load exposed to the core network.

LTE-LAN (or LTE-Hi) higher level requirements may include potential requirements on architecture, such as cost-effectiveness and lower OPEX, enhanced traffic offloading other than LIPA for LTE femto (simpler solution), less CN involvement with ICT friendly features, and new features enabled—D2D and a single/dual radio connection. Focused topics may include a cost effective LTE-Hi architecture—AP capability sharing, architecture support for new features—dual radio connection, an ICT friendly LTE-Hi architecture with less CN involvement, and enhanced flexible offloading of macro network services with LTE-Hi specific features. The requirement for less involvement of CN operation of a LTE-LAN network towards means that LTE-Hi local access control and session management functions like authentication, authorization and bearer management that normally are taken care by MME (EPC) are handled at EUTRAN and LTE-LAN level for accessing and using the LTE-LAN network and its resources in a flexible manner, e.g. by supporting dual radio connections.

In an HeNB sub-system, UE is in a single-radio mode all the time, i.e. if UE is handed over from a macro-eNB to use radio resources of HeNB, and if then a target HeNB takes the role of a serving eNB to UE requiring transfer of full eNB UE context data to HeNB and sharing security keys/data of the macro network. With a current 3GPP LTE architecture, on an AS layer, UE maintains only one RRC connection to E-UTRAN. On an NAS layer, in an ECM_CONNECTED state, UE maintains only one signalling connection to the core network (RRC connection+S1_MME connection). In the ECM_CONNECTED state, MME maintains only one eNB_ID for UE. In a CA case, this eNB_D is to be derived for E-CGI of PcelI. In an ECM_IDLE state, MME only maintains one location information (TAI) for UE.

Carrier aggregation solutions have been studied in 3GPP, wherein a secondary radio path may be using the same RAT or I-RAT (e.g. LTE-HSPA CA and radio level dynamic flow switching between 3GPP and WLAN).

Also inter-site CA with LTE has been studied, wherein DL is transmitted via a macro-eNB (Pceil) and UL is transmitted via a pico cell (Scell). A common feature in CA solutions is that they are aggregating user traffic using multiple radio paths on the layers below layer-3 (at a radio link layer).

Even if LTE-Hi APs were comparable with Scells in the inter-site CA solutions (LTE-HI APs are assumed to separate entities from eNBs located at different sites), the LTE-LAN architecture according to an exemplary embodiment is better in providing a flexible inter-working solution between a wide area (macro network) and LA (local area network) mobile broadband services in the spirit of an ITU IMT-A system.

An E-RAB offload feature supported by the LTE-LAN network architecture according to an exemplary embodiment is assumed to be working on the layer-3, i.e. it is not comparable with the above CA features at the radio link layer.

LTE carrier aggregation with standard UEs has been proposed regarding carrier aggregation at L3 (layer-3), by using two ordinary UEs coupled together (e.g. LTE modems connected to different USB ports in a laptop) and by combining two radio paths, i.e. “carriers” in a serving eNB. This kind of dual radio scenario, however, does not issue any specific network architecture.

An exemplary embodiment discloses a LTE-LAN network architecture that, depending on a deployment model, is capable of supporting a stand-alone mode for locally provided services without CN (i.e. EPC or EPS) involvement, and a flexible single/dual radio mode in control of E-UTRAN to offload macro LTE network resources to use LTE-LAN network resources on demand.

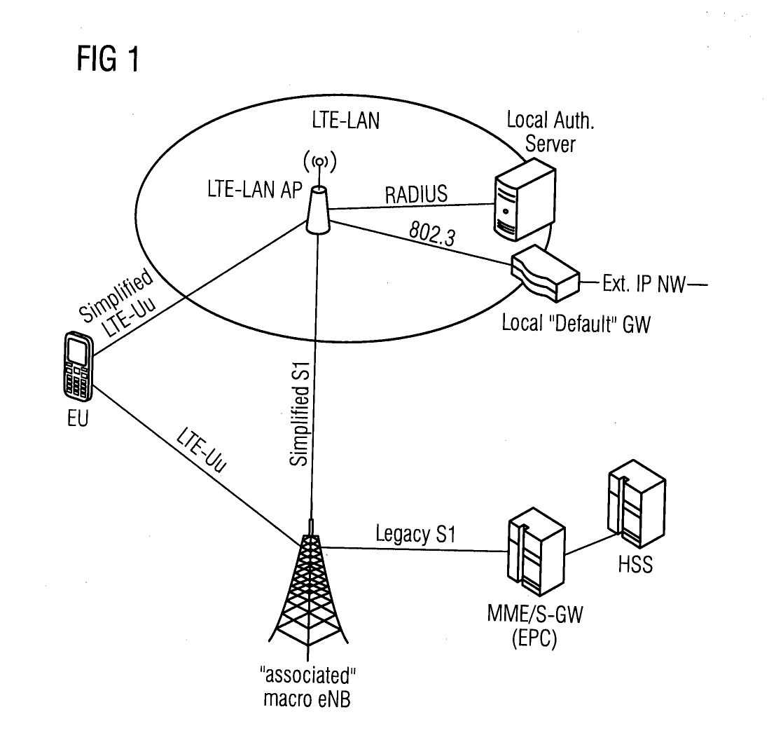

FIG. 1 illustrates the LTE-LAN network architecture with exemplary network entities and interfaces between these entities. LTE-LAN applies a new LTE-like radio interface that is shown in FIG. 1 as a “simplified LTE-Uu” interface. Due to the requirement of less CN involvement the LTE-LAN network according to an exemplary embodiment supports a “stand-alone” mode where the LTE-LAN network is working autonomously by providing a basic wireless broadband access with UE traffic routing to a local LAN/IP network directly from LTE-LAN AP and to the Internet via a default GW of this local LAN/IP network. This autonomous “stand-alone” mode operation is useful especially in the cases where the overlaying macro network service coverage is missing or UE with a LTE-LAN radio has not obtained a subscription from the macro mobile network operator. The local LAN transport network may include an ordinary Ethernet-based LAN, i.e. IEEE 802.3, as shown in FIG. 1. In general this stand-alone LTE-LAN operation resembles existing Wi-Fi network solutions except that the radio interface is using said simplified LTE-Uu interface.

For an autonomous stand-alone mode operation the LTE-LAN network provides means for UE authentication and authorization to use services provided by the LTE-LAN network. This may be implemented by using similar methods as applied in WLAN (IEEE 802.11i) but modified to carry the authentication protocol messages, e.g. EAP encapsulated into LTE Uu RRC (radio resource control) messages. In FIG. 1, there is shown an optional local authentication server that may be a RADIUS server or a diameter server like the one used in enterprise Wi-Fi networks, also enabling support of UEs without a SIM-card, or without necessitating a subscription from a mobile network operator if needed.

UE with a LTE-LAN radio may not have a SIM-card or a subscription to macro network, so the LTE-LAN network should support using local user identifiers, instead of necessitating to reveal IMSI used in the macro network to LTE-LAN, and in general avoid sharing security keys/data of the macro network (E-UTRAN and EPC) with the LTE-LAN network. This separation of user identifiers and security context is required, as a LTE-LAN network may be considered as an untrusted access from a macro LTE network point of view. This “untrusting” applies to the cases where the LTE-LAN network is administered and operated by some party other than the mobile network operator but where the mobile network operator has an agreement with the LTE-LAN operator to use available LTE-LAN network resources for offloading the macro network.

UE requesting a LTE-LAN service may be identified and authorized locally in the LTE-LAN network, for example, by using:
a unique device HW identifier, such as a L2 address of a LAN interface IMEI,
ICCID (integrated circuit card ID) of the SIM card; unique UICC (SIM) card serial number; identifies a physical SIM card, not the SIM application stored into it,
a temporary LTE-LAN identifier provided by LTE-LAN AP (this may be sufficient for open LTE-LAN access),
LTE-LAN credentials (username/password, network access identifier (RFC 4282), secure ID etc.) maintained in case an optional local authentication server, e.g. RADIUS server, is provided in LTE-LAN,
a second SIM-card to access LTE-LAN provided local services.

In an exemplary embodiment, for LTE-LAN provided services in the stand-alone mode LTE-LAN AP is allowed to configure, for an authorized UE, a radio bearer service with access to the LTE-LAN network and/or internet by using locally provisioned QoS rules, i.e. due to simplicity no information exchange towards the core network (EPC) is necessary like it is in a 3GPP LIPA feature for HeNBs.

An exemplary embodiment enables supporting a single/dual radio mode to offload macro LTE network resources to use LTE-LAN network resources, possibly operated by a third party, to a macro mobile network operator. An exemplary embodiment enables integrating the LTE-LAN network as a untrusted sub-system to E-UTRAN, the offloaded macro LTE network resources at the AS layer being in control of an associated macro-eNB, wherein a “simplified S1” application protocol interface is used for interworking as shown in FIG. 1. This S1-like interface may also support some X2 application protocol functions for radio resource control and mobility management purposes.

The associated macro-eNB is supposed to be the sole controller of the offloaded macro network resources/services when using the LTE-LAN sub-system resources. LTE-LAN supported local services which may run in parallel with these offloaded macro network services, may be handled as a LTE-LAN network internal issue (no CN involvement required), but on demand it may be possible to let the mobile operator to also control these LTE-LAN local services via the associated macro-eNB, i.e. decision about LTE-LAN local service establishments with local IP breakout from LTE-LAN AP is carried out optionally in, or via, the associated macro-eNB.

In order not to weaken security provided by the macro mobile network, an exemplary embodiment discloses that the associated macro-eNB stores eNB UE context data (provided by MME) as usual, resolves binding to the LTE-LAN UE context in LTE-LAN AP, and for the offloaded E-RAB services derives required LTE-LAN parameters (e.g. E-RABs) from eNB UE context parameters by using temporary user identifiers negotiated between the associated eNB, LTE-LAN AP and UE.

In the supported dual radio mode it is also assumed that the offloaded E-RABs (on the U-plane) and UE-to-eNB control signalling is passed transparently via the LTE-LAN sub-system. This secondary connection applies same e2e ciphering as used over a primary macro LTE radio connection, i.e. when UE communicates to the associated macro-eNB via the LTE-LAN sub-system (secondary connection), user data/control messages become secure-tunnelled and no sensitive information from the macro network is revealed to LTE-LAN AP. Thus, the LTE-LAN network may be operated by a mobile operator, in which case a LTE-LAN may be considered as a trusted access network. Thus, standardizing too many options in 3GPP may be avoided.

The same secure tunnelling via the LTE-LAN sub-system applies also for a possible single LTE-LAN radio case where a user/UE with a SIM-card is willing to consume EPC provided services without radio connectivity to the macro network. In an exemplary embodiment, the associated macro-eNB is in a role of the serving eNB towards EPC but each UE related service uses resources of the LTE-LAN sub-system. This may require that a LTE-LAN cell is exposed to EPC as one of the cells belonging to the associated macro-eNB (like HeNB GW exposes HeNBs to EPC), and the associated macro-eNB behaves towards EPC accordingly, e.g. as a result of a UE-triggered service request procedure there is created an eNB UE context based on which the associated macro-eNB configures bearer services to use the LTE-LAN network resources at the AS layer.

In order to let the associated macro-eNB to control its offloaded radio resources and mobility at the AS level towards LTE-LAN AP, it may be sufficient that RAN application protocol signalling between the associated macro-eNB and LTE-LAN AP is run over IPSec by using a security association between these nodes. The required security association (SA) between eNB and LTE-LAN AP may be established in advance e.g. by using O&M.

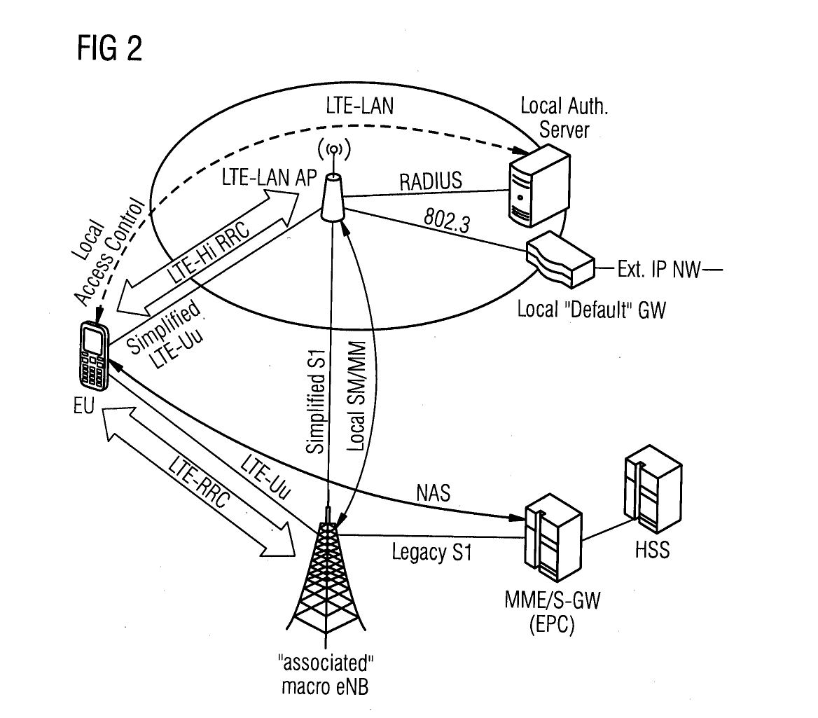

FIG. 2 illustrates applied control interfaces in an LTE-LTE-LAN dual radio mode. The control interfaces in the LTE-LTE-LAN dual radio mode may be as follows:
UE has a NAS signalling connection to EPC via the serving macro-eNB by using LTE-RRC as usual,
UE has RRM, bearer/mobility management towards the serving serving eNB as usual; this may be considered as a main RRC connection in the LTE-LAN dual radio mode,
UE has a simultaneous LTE-LAN RRC connectivity to LTE-LAN AP providing 1) local access control signalling towards LTE-LAN, 2) local radio link management (RRM), 3) local bearer/mobility management signalling for LTE-LAN provided services,
the associated macro-eNB has a local control interface (“simplified S1”) towards the LTE-LAN sub-system, with following characteristics 1) the control for the offloaded macro network resources is handled in the associated macro-eNB transparently to EPC like the LTE-LAN resources were part of the macro-eNB resources, i.e. they are macro-eNB internal issues, 2) macro-eNB may emulate a local MME in the local E-RAB and mobility management while controlling the offloaded E-RAB services (L3 offloading) via LTE-LAN AP, 3) the macro-eNB may also be capable of controlling the LTE-LAN AP radio resources for multi-path radio connections at the link layer (L2) so that LTE-LAN AP is in a role of a RRC proxy; this enables developing new multi-radio features using multiple data paths, e.g. LTE-LTE-LAN carrier aggregation at RAN-level on demand.

The LTE-LAN network architecture according to an exemplary embodiment supports flexible offloading of macro network bearer services in control of the associated macro-eNB in order to use resources in the LTE-LAN sub-system either in the dual or single radio modes.

The scenario for a LTE-LAN single radio mode is as follows:

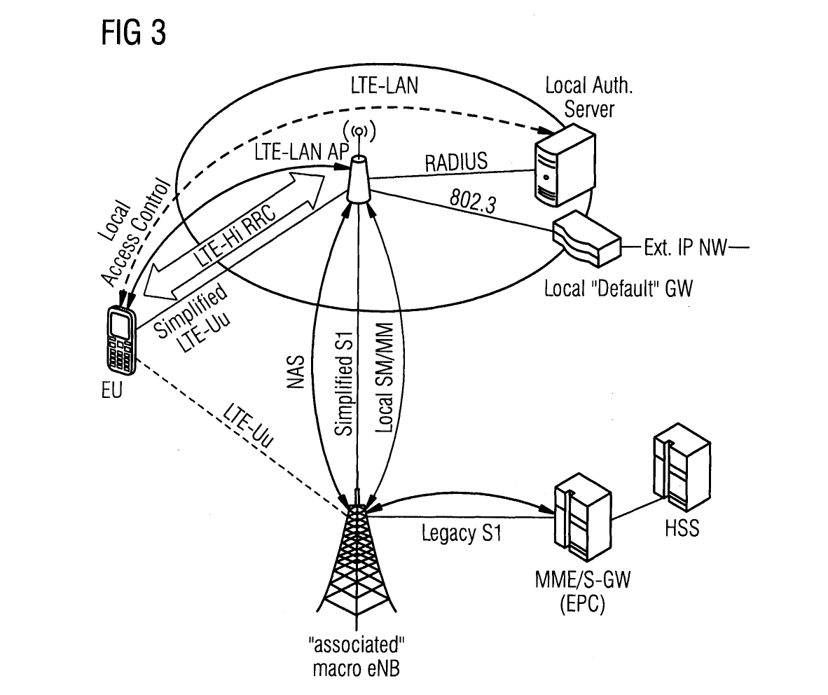

When UE with a SIM card and subscription to a macro network has established a radio link connectivity to LTE-LAN AP, but macro network coverage is not available, UE may request not only local LTE-LAN service(s) but also services consumed via EPC. FIG. 3 illustrates control interfaces in a LTE-LAN single radio mode supporting services consumed via the macro network. In this LTE-LAN single radio mode it is assumed that LTE-LAN AP and its neighbouring macro-eNB have established a simplified S1 connection in advance. This may be considered as a common signalling channel on the S1-MME interface.

Due to security reasons, upon service setup there may be created eNB UE context data stored in the associated macro-eNB, and the LTE-LAN sub-system maintains only the LTE-LAN UE context required derived from the eNB UE context for link layer resource management purposes. Now the LTE-LAN AP may relay ciphered UE-to-eNB and UE-to-MME (NAS) signalling messages transparently, i.e. there is created a secured tunnel from UE to the macro network via the LTE-LAN interfaces.

Again herein, as proposed in connection with the dual radio mode, the associated macro-eNB may apply AS-level RAN application protocol signalling towards LTE-LAN AP in order to configure the required LTE-LAN resources for the bearer services according to the eNB UE context that is the result of the UE negotiations with EPC at the NAS-level signalling.

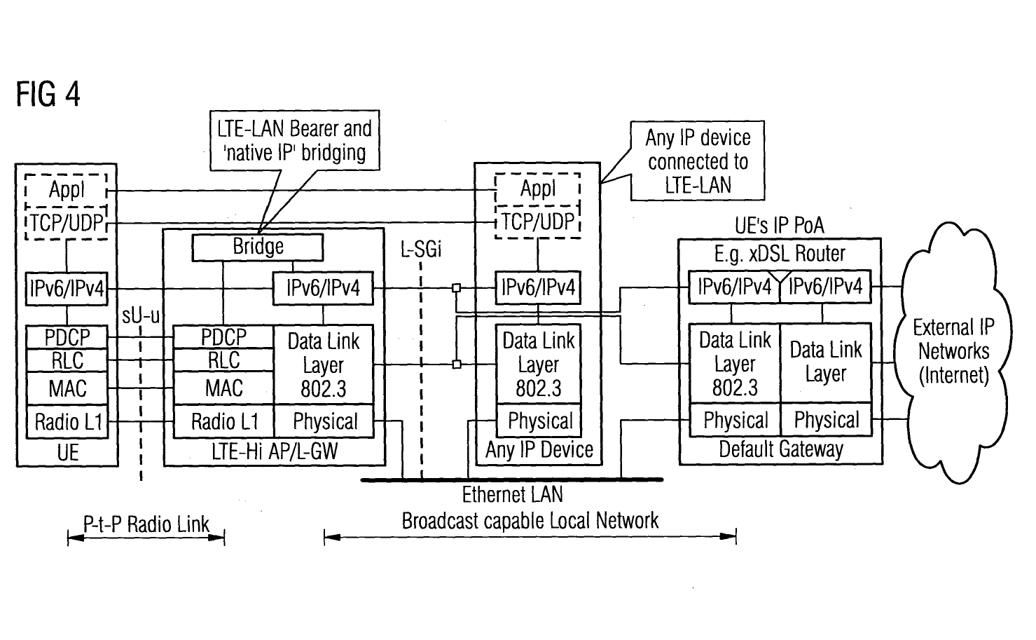

FIG. 4 illustrates an example of a U-plane protocol stack for LTE-LAN bearer services in the LTE-LAN network “stand-alone” operation mode (local IP breakout). LTE-Hi AP (or LTE-LAN AP) is able to provide a direct U-plane connectivity to the local packet switched network (e.g. LTE-LAN zone) via its co-located “P-GW like” local GW (L-GW) function. A simple bridging function between data radio bearer and “native IP” to Local LAN/IP network provides the required U-plane interface (L-SGi) for LTE-LAN bearer service traffic, i.e. S1 like U-plane tunnelling to an external L-GW as used in the current 3GPP LIPA feature, may be omitted (actually this bridging function is a lot like the one used in WLAN APs except that the radio interface is totally different). LTE-Hi AP only needs to know the UE IP address associated with the LTE-Hi E-RAB context in order to perform local routing/forwarding in the LTE-LAN service. There is no need to separate the L-GW control interface from EPC as the simple bridging function may be controlled just by using the simplified S1 control interface from the associated macro-eNB.

FIG. 5 illustrates an example of a U-plane protocol stack for the LTE-LTE-LAN dual radio mode to offload LTE macro network bearer services via the LTE-LAN sub-system. A data path between UE and eNB via LTE-Hi AP is ciphered and possibly header compressed at an upper “super PDCP” layer, i.e. no security issues arise due to using the LTE-LAN resources as a secondary user traffic data path.

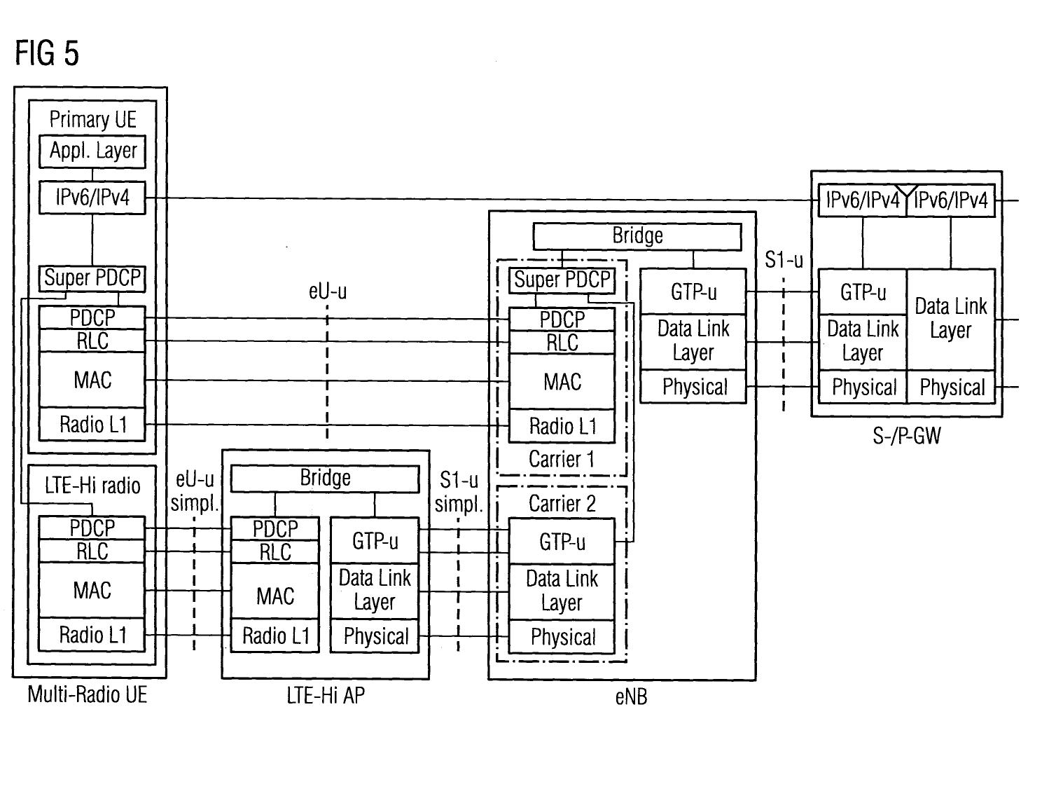

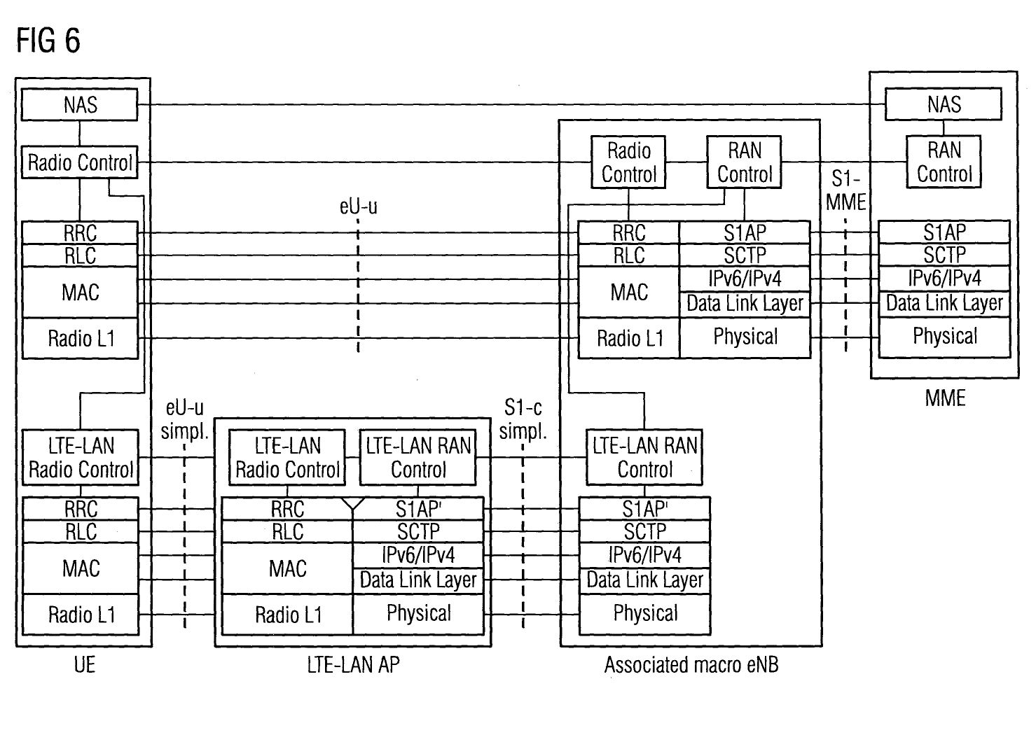

FIG. 6 illustrates an example of a C-plane protocol stack for the LTE LTE-LAN dual radio mode to offload LTE macro network bearer services via the LTE-LAN sub-system. A primary control interface between UE and the associated macro eNB is using a direct radio link connection (eU-c in FIG. 6) and works as usual except for supporting control of a secondary radio path. A secondary control interface for LTE-LAN radio path management (UE to LTE-LAN AP) works as an autonomous sub-system allowing the primary application layer control entities in UE and the associated eNB to use and configure its resources.

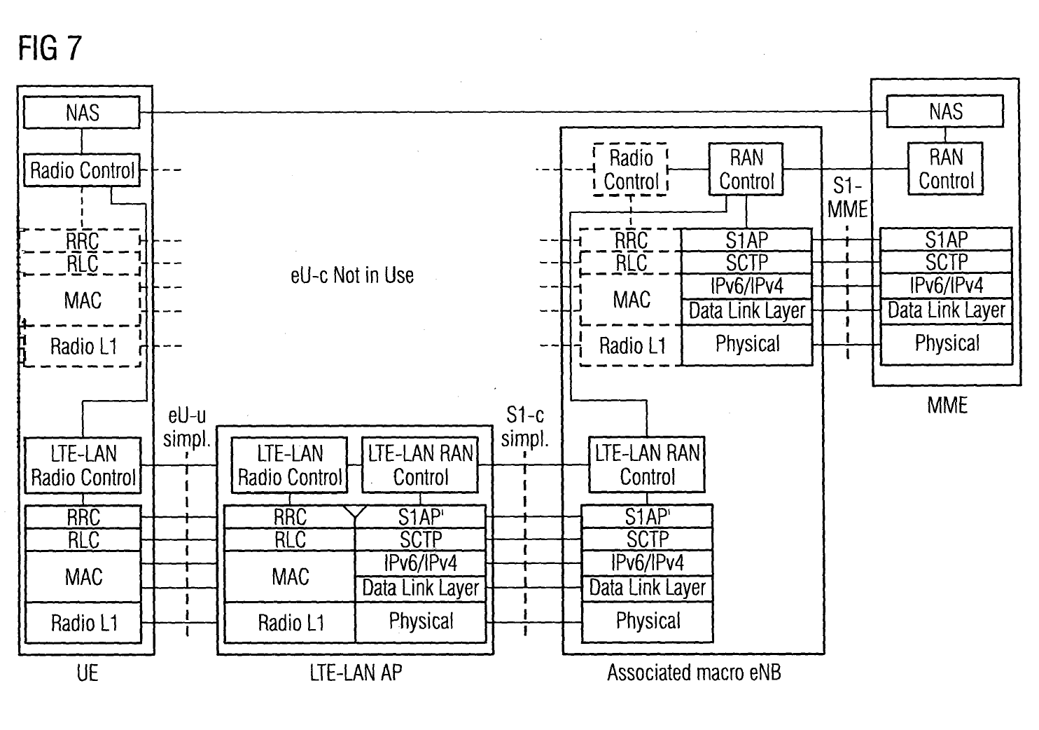

FIG. 7 illustrates an example of a C-plane protocol stack for the LTE-LAN single radio mode to offload LTE macro network bearer services via the LTE-LAN sub-system (i.e. to use services from the macro network). In the LTE-LAN single radio mode the e2e signalling between UE and the macro LTE network are passed transparently via the LTE-LAN sub-system in a similar manner as e.g. NAS messages are passed from UE to MME encapsulated in ciphered NAS containers over RRC and SlAP. The associated macro-eNB is as an anchor to EPC and stores eNB UE context data as if UE were connected directly over the eU-c radio link connection (now in single radio mode not in use). An application layer “RAN control” entity in the associated macro-eNB now controls a “LTE-LAN RAN control” entity to let it create the required bearer services (i.e. “bit-pipes”) over the LTE-LAN sub-system to pass UE's EPS bearers consuming services provided by the mobile operator.

In an exemplary embodiment, no sensitive macro network related context is exposed to the LTE-LAN network but still the macro network is able to use the LTE-LAN network resources in control of the associated macro-eNB for offloading. An exemplary embodiment is applicable to various deployment models, i.e. it does not matter whether the LTE-LAN network is operated by the mobile operator or by a third party local operator. This may be a sole enabler for heterogeneous network deployments in the future. In an exemplary embodiment, legal interception works for offloaded EPS bearer services as usual and for the users with a SIM card also a binding between IMSI and local user identifiers used in the LTE-LAN network may be solved if desired. An exemplary embodiment, has a lot in common with a proposed LTE-Wi-Fi carrier aggregation feature when seen from UE and eNB implementation and specification work point of view in 3GPP, i.e. applicability of these local area network and wide area network inter-working principles may be used together with any radio access technology in local area networks. In an exemplary embodiment, LTE-LAN AP takes care of a fast loop radio link control over the simplified Uu interface, enabling less stringent backhaul requirements for the simplified S1 interface. By adopting an LTE like radio bearer/link model, LTE-LAN may be made to support fair and intelligent resource sharing when multiple UEs are connected to the same AP. It should be noted that such a function is not possible e.g. in WLAN due to its legacy burden.

Thus, a LTE-LAN architecture according to an exemplary embodiment supports single and dual radio modes in control of E-UTRAN. Core network transparent local radio access sub-system providing local area services (stand-alone) and E-RAB bearer service offload for multi-radio capable UEs in control of their serving macro-eNB (E-UTRAN node). The new LTE-LAN network architecture that depending on the deployment model is made capable of supporting a stand-alone mode for locally provided services without CN (i.e. EPC or EPS) involvement and a flexible single/dual radio mode in control of E-UTRAN to offload macro LTE network resources to use LTE-LAN network resources on demand.

Exemplary embodiments will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Like reference numerals refer to like elements throughout.

The present invention is applicable to any user terminal, network node, server, corresponding component, and/or to any communication system or any combination of different communication systems that support a local radio access network sub-system. The communication system may be a fixed communication system or a wireless communication system or a communication system utilizing both fixed networks and wireless networks. The protocols used, the specifications of communication systems, servers and user terminals, especially in wireless communication, develop rapidly. Such development may require extra changes to an embodiment. Therefore, all words and expressions should be interpreted broadly and they are intended to illustrate, not to restrict, the embodiment.

In the following, different embodiments will be described using, as an example of a system architecture whereto the embodiments may be applied, an architecture based on LTE (long term evolution) network elements, without restricting the embodiment to such an architecture, however. The embodiments described in these examples are not limited to the LTE radio systems but can also be implemented in other radio systems, such as UMTS (universal mobile telecommunications system), GSM, EDGE, WCDMA, bluetooth network, WLAN or other fixed, mobile or wireless network. In an embodiment, the presented solution may be applied between elements belonging to different but compatible systems such as LTE and UMTS.

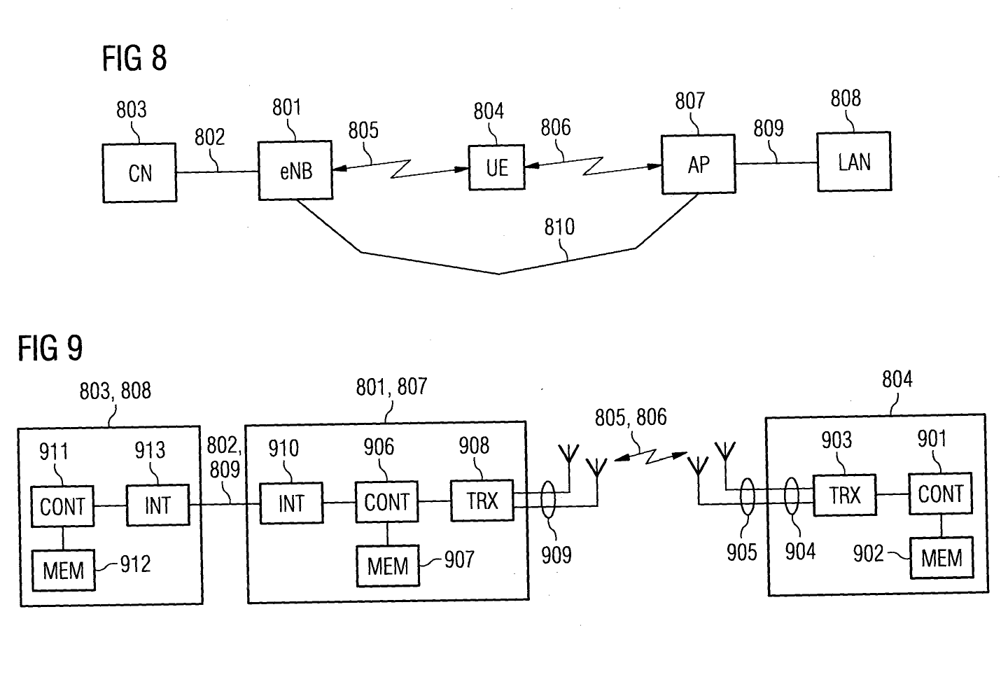

A general architecture of a communication system is illustrated in FIG. 8. FIG. 8 is a simplified system architecture only showing some elements and functional entities, all being logical units whose implementation may differ from what is shown. The connections shown in FIG. 8 are logical connections; the actual physical connections may be different. It is apparent to a person skilled in the art that the systems also comprise other functions and structures. It should be appreciated that the functions, structures, elements and the protocols used in or for group communication, are irrelevant to the actual invention. Therefore, they need not to be discussed in more detail here.

The exemplary radio system of FIG. 8 comprises a network node 801 of a network operator. The network node 801 may include e.g. an LTE base station (eNB), radio network controller (RNC), or any other network element, or a combination of network elements. The network node 801 may be connected to one or more core network (CN) elements 803 (such as a mobile switching centre (MSC), MSC server (MSS), mobility management entity (MME), gateway GPRS support node (GGSN), serving GPRS support node (SGSN), home location register (HLR), home subscriber server (HSS), visitor location register (VLR)) via a connection 802 (also referred to as a legacy S1 interface). In FIG. 8, the radio network node 801 that may also be called eNB (enhanced node-B, evolved node-B) or macro network apparatus of the radio system, hosts the functions for radio resource management in a public land mobile network. FIG. 8 shows one or more user equipment 804 located in the service area of the radio network node 801. The user equipment refers to a portable computing device, and it may also be referred to as a user terminal. Such computing devices include wireless mobile communication devices operating with or without a subscriber identification module (SIM) in hardware or in software, including, but not limited to, the following types of devices: mobile phone, smart-phone, personal digital assistant (PDA), handset, laptop computer. In the example situation of FIG. 8, the user equipment 804 is capable of connecting to the radio network node 801 via a connection 805 (also referred to as a LTE-Uu interface). In the example situation of FIG. 8, the user equipment 804 is further capable of connecting to a local radio network node 807 via a connection 806 (also referred to as a simplified LTE-Uu interface). The local radio network node 807 may include e.g. an LTE-LAN access point (AP), LTE-HI access point, or any other network element, or a combination of network elements. The network node 807 may be connected to one or more local network (LAN) elements 808 (such as a local authentication server, local gateway) via a connection 809 (e.g. RADIUS interface or IEEE 802.3 interface). The local network node 807 may be connected to the macro network node 801 via a connection 810 (also referred to as a simplified S1 interface).

FIG. 9 is a block diagram of an apparatus according to an embodiment of the invention. FIG. 8 shows a user equipment 804 located in the area of a radio network node 801, 807. The user equipment 804 is configured to be in connection with the radio network node 801, 807. The user equipment or UE 804 comprises a controller 901 operationally connected to a memory 902 and a transceiver 903. The controller 901 controls the operation of the user equipment 804. The memory 902 is configured to store software and data. The transceiver 903 is configured to set up and maintain a wireless connection 805, 806 to the radio network node 801, 807. The transceiver is operationally connected to a set of antenna ports 904 connected to an antenna arrangement 905. The antenna arrangement 905 may comprise a set of antennas. The number of antennas may be one to four, for example. The number of antennas is not limited to any particular number. The user equipment 804 may also comprise various other components, such as a user interface, camera, and media player. They are not displayed in the figure due to simplicity. The radio network node 801, 807, such as an LTE base station (eNode-B, eNB) or LTE-LAN access point (AP), comprises a controller 906 operationally connected to a memory 907, and a transceiver 908. The controller 906 controls the operation of the radio network node 801, 807. The memory 907 is configured to store software and data. The transceiver 908 is configured to set up and maintain a wireless connection to the user equipment 804 within the service area of the radio network node 801, 807. The transceiver 908 is operationally connected to an antenna arrangement 909. The antenna arrangement 909 may comprise a set of antennas. The number of antennas may be two to four, for example. The number of antennas is not limited to any particular number. The radio network node 801, 807 may be operationally connected (directly or indirectly) to another network element 803, 808 of the communication system, such as a radio network controller (RNC), a mobility management entity (MME), an MSC server (MSS), a mobile switching centre (MSC), a radio resource management (RRM) node, a gateway GPRS support node, an operations, administrations and maintenance (OAM) node, a home location register (HLR), a visitor location register (VLR), a serving GPRS support node, a gateway, and/or a server, via an interface 910. The network node 803, 808 comprises a controller 911 operationally connected to a memory 912, and an interface 913. The controller 911 controls the operation of the network node 803, 808. The memory 912 is configured to store software and data. The interface 913 is configured to connect to the radio network node 801, 807 via a connection 802, 809. The embodiments are not, however, restricted to the network given above as an example, but a person skilled in the art may apply the solution to other communication networks provided with the necessary properties. For example, the connections between different network elements may be realized with internet protocol (IP) connections.

Although the apparatus 801, 803, 807, 808 has been depicted as one entity, different modules and memory may be implemented in one or more physical or logical entities. The apparatus may also be a user terminal which is a piece of equipment or a device that associates, or is arranged to associate, the user terminal and its user with a subscription and allows a user to interact with a communications system. The user terminal presents information to the user and allows the user to input information. In other words, the user terminal may be any terminal capable of receiving information from and/or transmitting information to the network, connectable to the network wirelessly or via a fixed connection. Examples of the user terminals include a personal computer, a game console, a laptop (a notebook), a personal digital assistant, a mobile station (mobile phone), a smart phone, and a line telephone.

The apparatus 801, 803, 807, 808 may generally include a processor, controller, control unit or the like connected to a memory and to various interfaces of the apparatus. Generally the processor is a central processing unit, but the processor may be an additional operation processor. The processor may comprise a computer processor, application-specific integrated circuit (ASIC), field-programmable gate array (FPGA), and/or other hardware components that have been programmed in such a way to carry out one or more functions of an embodiment.

The memory 902, 907, 912 may include volatile and/or non-volatile memory and typically stores content, data, or the like. For example, the memory 902, 907, 912 may store computer program code such as software applications (for example for the detector unit and/or for the adjuster unit) or operating systems, information, data, content, or the like for a processor to perform steps associated with operation of the apparatus in accordance with embodiments. The memory may be, for example, random access memory (RAM), a hard drive, or other fixed data memory or storage device. Further, the memory, or part of it, may be removable memory detachably connected to the apparatus.

The techniques described herein may be implemented by various means so that an apparatus implementing one or more functions of a corresponding mobile entity described with an embodiment comprises not only prior art means, but also means for implementing the one or more functions of a corresponding apparatus described with an embodiment and it may comprise separate means for each separate function, or means may be configured to perform two or more functions. For example, these techniques may be implemented in hardware (one or more apparatuses), firmware (one or more apparatuses), software (one or more modules), or combinations thereof. For a firmware or software, implementation can be through modules (e.g., procedures, functions, and so on) that perform the functions described herein. The software codes may be stored in any suitable, processor/computer-readable data storage medium(s) or memory unit(s) or article(s) of manufacture and executed by one or more processors/computers. The data storage medium or the memory unit may be implemented within the processor/computer or external to the processor/computer, in which case it can be communicatively coupled to the processor/computer via various means as is known in the art.

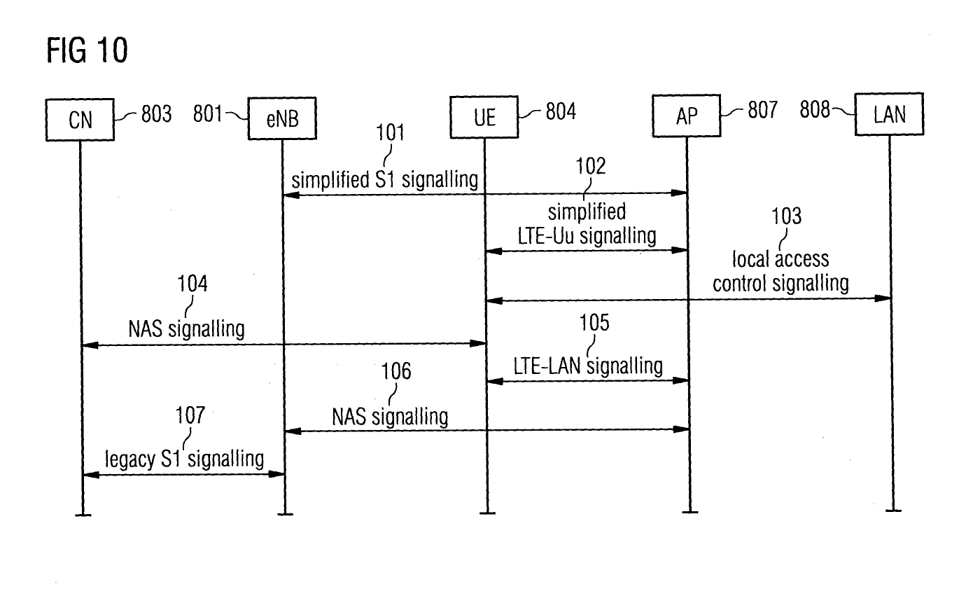

The signalling chart of FIG. 10 illustrates the required signalling. In the example of FIG. 10, a network node 801 (which may comprise e.g. a LTE-capable base station (eNode-B, eNB)) may establish a connection 101 with a local network apparatus 807 (which may comprise e.g. a LTE-LAN access point AP 807) for transmitting simplified S1 signalling between eNB and AP. A network node 804 (which may comprise e.g. a LTE-capable user terminal UE) may, in a stand-alone operation mode, establish a connection 102 with the local network apparatus 807 for transmitting simplified LTE-Uu signalling between UE and AP. The user terminal 804 may establish a connection 103 with a local network apparatus 808 (e.g. local authentication server or local gateway) for transmitting local access control signalling between UE and LAN. In a dual radio mode, the user terminal 804 may establish a connection 104 with a macro network apparatus 803 (e.g. enhanced packet core apparatus, such as a mobility management entity (MME), serving gateway (S-GW) or home subscriber server (HSS)) for transmitting NAS signalling between UE and CN. In a single radio mode, the user terminal 804 may establish a connection 105 with the access point 807 for transmitting LTE-LAN signalling between UE and AP. Then the access point 807 may establish a connection 106 with the base station 801 for transmitting NAS signalling between eNB and AP, wherein the base station 801 may establish a connection 107 with the macro network apparatus 803 for transmitting legacy S1 signalling between eNB and CN.

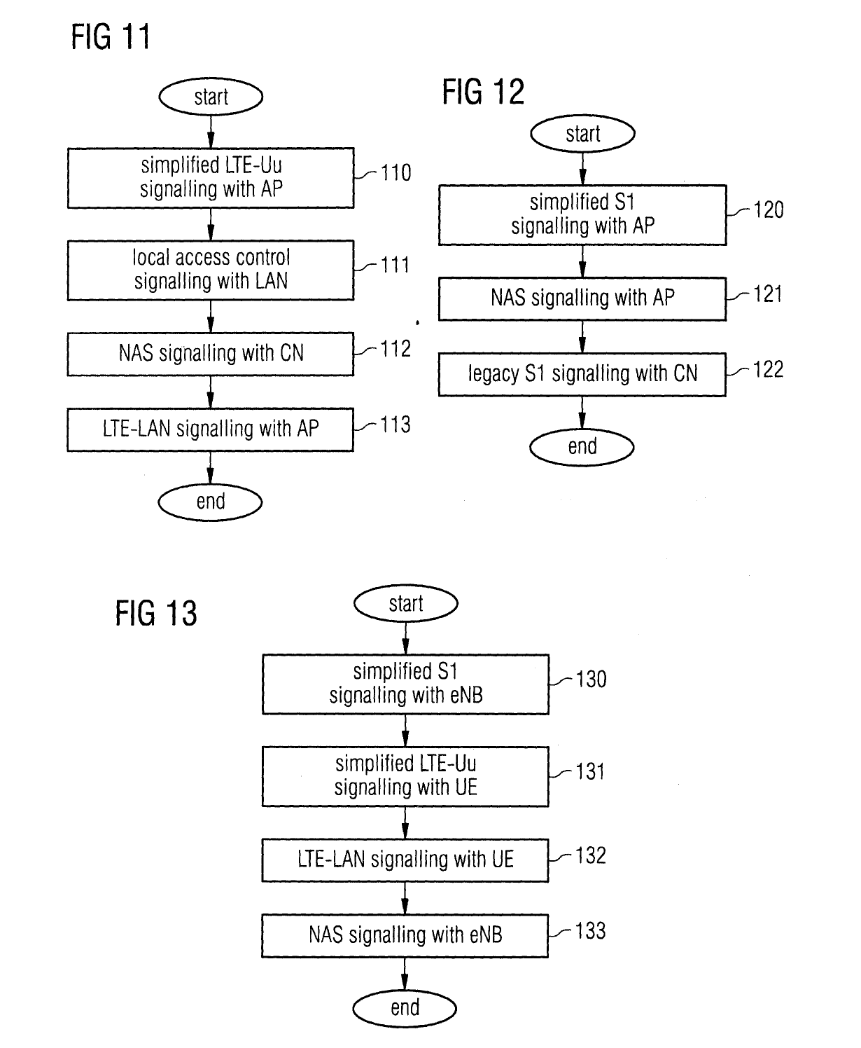

FIG. 11 is a flow chart illustrating an exemplary embodiment. The apparatus 804, which may comprise e.g. a network element (network node, e.g. a user terminal, UE), transmits/receives, in item 110, to/from a local network apparatus 807 (which may comprise e.g. LTE-LAN access point AP 807) simplified LTE-Uu signalling. The apparatus 804 transmits/receives, in item 111, to/from a local network apparatus 808 (which may comprise e.g. local authentication server or local gateway 808) local access control signalling. The apparatus 804 transmits/receives, in item 112, to/from a macro network apparatus 803 (e.g. enhanced packet core apparatus, such as a mobility management entity (MME), serving gateway (S-GW) or home subscriber server (HSS)) NAS signalling. The apparatus 804 transmits/receives, in item 113, to/from the local network apparatus 807 LTE-LAN signalling.

FIG. 12 is a flow chart illustrating an exemplary embodiment. The apparatus 801, which may comprise e.g. a network element (network node, e.g. a LTE-capable base station (eNode-B, eNB)), transmits/receives, in item 120, to/from a local network apparatus 807 (which may comprise e.g. LTE-LAN access point AP 807) simplified S1 signalling. The apparatus 801 transmits/receives, in item 121, to/from the local network apparatus 807 NAS signalling. The apparatus 801 transmits/receives, in item 122, to/from a macro network apparatus 803 (e.g. enhanced packet core apparatus, such as a mobility management entity (MME), serving gateway (S-GW) or home subscriber server (HSS)) legacy S1 signalling.

FIG. 13 is a flow chart illustrating an exemplary embodiment. The apparatus 803, which may comprise e.g. a network element (network node, e.g. an LTE-LAN access point (AP)), transmits/receives, in item 130, to/from a macro network apparatus 801 (which may comprise e.g. LTE-capable base station (eNode-B, eNB)) simplified S1 signalling. The apparatus 803 transmits/receives, in item 131, to/from a user terminal 804 (which may comprise e.g. LTE-capable user terminal) simplified LTE-Uu signalling. The apparatus 803 transmits/receives, in item 132, to/from the user terminal LTE-LAN signalling. The apparatus 803 transmits/receives, in item 133, to/from the macro network apparatus 801 NAS signalling.

The steps/points, signalling messages and related functions de-scribed above in FIGS. 1 to 13 are in no absolute chronological order, and some of the steps/points may be performed simultaneously or in an order differing from the given one. Other functions can also be executed between the steps/points or within the steps/points and other signalling messages sent be-tween the illustrated messages. Some of the steps/points or part of the steps/points can also be left out or replaced by a corresponding step/point or part of the step/point. The apparatus operations illustrate a procedure that may be implemented in one or more physical or logical entities. The signalling messages are only exemplary and may even comprise several separate messages for transmitting the same information. In addition, the messages may also contain other information.

Thus, according to an exemplary embodiment, there is provided a method for managing signalling interfaces in a communications system, supporting, in a communication apparatus, a stand-alone operation mode for using, without a core network involvement, bearer services provided by a local network; and supporting, in the communication apparatus, flexible single radio/dual radio modes for offloading resources of a macro network in order to use bearer services provided by the macro network either in the single radio mode or in the dual radio mode, wherein said offloading is controlled by an associated macro network apparatus.

According to another exemplary embodiment, there is provided a method for applying, between the communication apparatus and a local access point, a simplified LTE-Uu interface resembling an LTE radio interface.

According to yet another exemplary embodiment, there is provided a method for felling, on demand, a mobile operator to control LTE-LAN local services via the associated macro network apparatus, wherein decision on a LTE-LAN local service establishment with a local IP breakout from a local access point is carried out optionally in, or via, the associated macro network apparatus.

According to yet another exemplary embodiment, in the dual radio mode, offloaded enhanced radio access bearers and control signalling from the communication apparatus to the associated macro network apparatus are passed transparently via a LTE-LAN sub-system, wherein this secondary connection applies same e2e ciphering as used over a primary macro LTE radio connection.

According to yet another exemplary embodiment, in the single radio mode, as a result of service request procedure triggered by the communication apparatus, there is created an eNB UE context based on which the associated macro network apparatus is able to configure bearer services for using LTE-LAN network resources at an access stratum layer.

According to yet another exemplary embodiment, there is provided a method for applying control interfaces in the dual radio mode such that the communication apparatus has one or more of a non access stratum signalling connection interface to the core network via the associated macro network apparatus by using LTE radio resource control, a radio resource management, bearer management and mobility management interface towards the associated macro network apparatus, and a simultaneous LTE-LAN radio resource connectivity interface to a local access point.

According to yet another exemplary embodiment, there is provided an apparatus comprising at least one processor; and at least one memory including a computer program code, characterized in that the at least one memory and the computer program code are configured to, with the at least one processor, cause the apparatus to support a stand-alone operation mode for using, without a core network involvement, bearer services provided by a local network; and support flexible single radio/dual radio modes for offloading resources of a macro network in order to use bearer services provided by the macro network either in the single radio mode or in the dual radio mode, wherein said offloading is controlled by an associated macro network apparatus.

According to yet another exemplary embodiment, the at least one memory and the computer program code are configured to, with the at least one processor, cause the apparatus to on demand let a mobile operator to control LTE-LAN local services via the associated macro network apparatus, wherein decision on a LTE-LAN local service establishment with a local IP breakout from a local access point is carried out optionally in, or via, the associated macro network apparatus.

According to yet another exemplary embodiment, the at least one memory and the computer program code are configured to, with the at least one processor, cause the apparatus to apply, between the apparatus and a local access point, a simplified LTE-Uu interface resembling an LTE radio interface.

According to yet another exemplary embodiment, there is provided an apparatus comprising at least one processor; and at least one memory including a computer program code, characterized in that the at least one memory and the computer program code are configured to, with the at least one processor, cause the apparatus to control offloading resources of a macro network in order to provide bearer services to a user terminal, the user terminal supporting a stand-alone operation mode for using, without a core network involvement, bearer services provided by a local network, and a flexible single radio/dual radio modes for offloading resources of the macro network in order to use bearer services provided by the macro network either in the single radio mode or in the dual radio mode.

According to yet another exemplary embodiment, the at least one memory and the computer program code are configured to, with the at least one processor, cause the apparatus to store eNB UE context data provided by a mobility management entity, resolve binding to a LTE-LAN UE context regarding a local access point, and derive, for offloaded resources, required LTE-LAN parameters based on eNB UE context parameters by using temporary user identifiers negotiated between the associated macro network apparatus, the local access point and the user terminal.

According to yet another exemplary embodiment, the at least one memory and the computer program code are configured to, with the at least one processor, cause the apparatus to run radio access network application protocol signalling between the apparatus and a local access point is run over IPSec by using a security association between the apparatus and the local access point.

According to yet another exemplary embodiment, the at least one memory and the computer program code are configured to, with the at least one processor, cause the apparatus to apply a simplified S1 local control interface towards a LTE-LAN sub-system.

According to yet another exemplary embodiment, there is provided an apparatus comprising at least one processor; and at least one memory including a computer program code, characterized in that the at least one memory and the computer program code are configured to, with the at feast one processor, cause the apparatus to provide services of a local network to a user terminal, the user terminal supporting a stand-alone operation mode for using, without a core network involvement, bearer services provided by the local network, and a flexible single radio/dual radio modes for offloading resources of a macro network in order to use bearer services provided by the macro network either in the single radio mode or in the dual radio mode, wherein said offloading is controlled by an associated macro network node.

According to yet another exemplary embodiment, the at least one memory and the computer program code are configured to, with the at least one processor, cause the apparatus to locally identify and authorize a user terminal requesting a LTE-LAN service, by using one or more of a unique device hardware identifier, an integrated circuit card ID of a SIM card, a temporary LTE-LAN identifier provided by the apparatus, LTE-LAN credentials maintained if an optional local authentication server is provided in the local network, and a second SIM card capable of accessing local services provided by a LTE-LAN network.

According to yet another exemplary embodiment, the at least one memory and the computer program code are configured to, with the at least one processor, cause the apparatus to support using local user terminal identifiers, and to avoid sharing security keys of the macro network with a LTE-LAN network.

According to yet another exemplary embodiment, the at least one memory and the computer program code are configured to, with the at least one processor, cause the apparatus to on demand let a mobile operator to control LTE-LAN local services via the associated macro network node, wherein decision on a LTE-LAN local service establishment with a local IP breakout from a local access point is carried out optionally in, or via, the associated macro network node.

According to yet another exemplary embodiment, the at least one memory and the computer program code are configured to, with the at least one processor, cause the apparatus to apply, between the apparatus and a user terminal, a simplified LTE-Uu interface resembling an LTE radio interface.

According to yet another exemplary embodiment, the at least one memory and the computer program code are configured to, with the at least one processor, cause the apparatus to run radio access network application protocol signalling between the apparatus and the associated macro network node over IPSec by using a security association between the associated macro network node and the apparatus.

According to yet another exemplary embodiment, the at least one memory and the computer program code are configured to, with the at least one processor, cause the apparatus to relay ciphered signalling messages from the user terminal to the macro network apparatus via a local network interface by using secured tunnelling.

According to yet another exemplary embodiment, there is provided program code means adapted to perform any of the method steps when the program is run on a computer.

It will be obvious to a person skilled in the art that, as the technology advances, the inventive concept can be implemented in various ways. The invention and its embodiments are not limited to the examples described above but may vary within the scope of the claims.

### LIST OF ABBREVIATIONS

3GPP 3rd generation partnership project
AP access point
AS access stratum
BS base station
eNB enhanced node-B
EPC evolved packet core
EPS evolved packet system
EUTRAN evolved UMTS terrestrial radio access network
HeNB home enhanced node-B
HSS home subscriber server
HW hardware
ICCID integrated circuit card identifier
ID identity
IMEI international mobile equipment identity
IMSI international mobile subscriber identity
LTE long term evolution
LAE local area evolution
LAN local area network
MAC medium access control
MME mobility management entity
NAI network access identifier
NAS non-access stratum
PLMN public land mobile network
RADIUS remote authentication dial-in user service
RAN radio access network
RRC radio resource control
SAE system architecture evolution
SGSN serving GPRS support node
SIM subscriber identity module
SN support node
S-TMSI SAE temporary mobile subscriber identity
UE user equipment
UICC universal integrated circuit card
QoS quality of service
Wi-Fi wireless fidelity
C-plane control plane
U-plane user plane
CN core network
UMTS universal mobile telecommunications system
GPRS general packet radio service
CA carrier aggregation
ICT information and communication technology
TAI international atomic time
LIPA local IP access
RAT radio access technology
I-RAT inter radio access technology
HSPA high speed packet access
DL downlink
WLAN wireless local area network
E-RAB enhanced radio access bearer
S-GW serving gateway

1-21. (canceled)

22. A method of managing signalling interfaces in a communications system, characterized by
supporting, in a communication apparatus, a stand-alone operation mode for using, without a core network involvement, bearer services provided by a local network; and
supporting, in the communication apparatus, flexible single radio/dual radio modes for offloading resources of a macro network in order to use bearer services provided by the macro network either in the single radio mode or in the dual radio mode, wherein said offloading is controlled by an associated macro network apparatus.

23. A method according to claim 22, characterized by
applying, between the communication apparatus and a local access point, a simplified LTE-Uu interface resembling an LTE radio interface.

24. A method according to claim 22, characterized by
letting, on demand, a mobile operator to control LTE-LAN local services via the associated macro network apparatus, wherein decision on a LTE-LAN local service establishment with a local IP breakout from a local access point is carried out optionally in, or via, the associated macro network apparatus.

25. A method according to claim 22, characterized in that
in the dual radio mode, offloaded enhanced radio access bearers and control signalling from the communication apparatus to the associated macro network apparatus are passed transparently via a LTE-LAN sub-system, wherein this secondary connection applies same e2e ciphering as used over a primary macro LTE radio connection.

26. A method according to claim 22, characterized in that
in the single radio mode, as a result of service request procedure triggered by the communication apparatus, there is created an eNB UE context based on which the associated macro network apparatus is able to configure bearer services for using LTE-LAN network resources at an access stratum layer.

27. A method according to claim 22, characterized in that
applying control interfaces in the dual radio mode such that the communication apparatus has one or more of
a non access stratum signalling connection interface to the core network via the associated macro network apparatus by using LTE radio resource control,
a radio resource management, bearer management and mobility management interface towards the associated macro network apparatus, and
a simultaneous LTE-LAN radio resource connectivity interface to a local access point.

28. An apparatus comprising
at least one processor; and
at least one memory including a computer program code, characterized in that the at least one memory and the computer program code are configured to, with the at least one processor, cause the apparatus to
support a stand-alone operation mode for using, without a core network involvement, bearer services provided by a local network; and
support flexible single radio/dual radio modes for offloading resources of a macro network in order to use bearer services provided by the macro network either in the single radio mode or in the dual radio mode, wherein said offloading is controlled by an associated macro network apparatus.

29. An apparatus according to claim 28, characterized in that the at least one memory and the computer program code are configured to, with the at least one processor, cause the apparatus to
on demand let a mobile operator to control LTE-LAN local services via the associated macro network apparatus, wherein decision on a LTE-LAN local service establishment with a local IP breakout from a local access point is carried out optionally in, or via, the associated macro network apparatus.

30. An apparatus according to claim 28, characterized in that the at least one memory and the computer program code are configured to, with the at least one processor, cause the apparatus to
apply, between the apparatus and a local access point, a simplified LTE-Uu interface resembling an LIE radio interface.

31. An apparatus comprising
at least one processor; and
at least one memory including a computer program code, characterized in that the at least one memory and the computer program code are configured to, with the at least one processor, cause the apparatus to
control offloading resources of a macro network in order to provide bearer services to a user terminal, the user terminal supporting a stand-alone operation mode for using, without a core network involvement, bearer services provided by a local network, and a flexible single radio/dual radio modes for offloading resources of the macro network in order to use bearer services provided by the macro network either in the single radio mode or in the dual radio mode.

32. An apparatus as claimed in claim 31, characterized in that the at least one memory and the computer program code are configured to, with the at least one processor, cause the apparatus to
store eNB UE context data provided by a mobility management entity,
resolve binding to a LTE-LAN UE context regarding a local access point, and
derive, for offloaded resources, required LTE-LAN parameters based on eNB UE context parameters by using temporary user identifiers negotiated between the associated macro network apparatus, the local access point and the user terminal.

33. An apparatus as claimed in claim 31, characterized in that the at least one memory and the computer program code are configured to, with the at least one processor, cause the apparatus to
run radio access network application protocol signalling between the apparatus and a local access point is run over IPSec by using a security association between the apparatus and the local access point.

34. An apparatus as claimed in claim 31, characterized in that the at least one memory and the computer program code are configured to, with the at least one processor, cause the apparatus to apply a simplified S1 local control interface towards a LTE-LAN sub-system.

35. An apparatus comprising
at least one processor; and
at least one memory including a computer program code, characterized in that the at least one memory and the computer program code are configured to, with the at least one processor, cause the apparatus to
provide services of a local network to a user terminal, the user terminal supporting a stand-alone operation mode for using, without a core network involvement, bearer services provided by the local network, and a flexible single radio/dual radio modes for offloading resources of a macro network in order to use bearer services provided by the macro network either in the single radio mode or in the dual radio mode, wherein said offloading is controlled by an associated macro network node.

36. An apparatus as claimed in claim 35, characterized in that the at least one memory and the computer program code are configured to, with the at least one processor, cause the apparatus to locally identify and authorize a user terminal requesting a LTE-LAN service, by using one or more of a unique device hardware identifier, an integrated circuit card ID of a SIM card, a temporary LTE-LAN identifier provided by the apparatus, LTE-LAN credentials maintained if an optional local authentication server is provided in the local network, and a second SIM card capable of accessing local services provided by a LTE-LAN network.

37. A apparatus as claimed in claim 35, characterized in that the at least one memory and the computer program code are configured to, with the at least one processor, cause the apparatus to
support using local user terminal identifiers, and to avoid sharing security keys of the macro network with a LTE-LAN network.

38. A apparatus as claimed in claim 35, characterized in that the at least one memory and the computer program code are configured to, with the at least one processor, cause the apparatus to
on demand let a mobile operator to control LTE-LAN local services via the associated macro network node, wherein decision on a LTE-LAN local service establishment with a local IP breakout from a local access point is carried out optionally in, or via, the associated macro network node.

39. An apparatus according to claim 35, characterized in that the at least one memory and the computer program code are configured to, with the at least one processor, cause the apparatus to
apply, between the apparatus and a user terminal, a simplified LTE-Uu interface resembling an LTE radio interface.

40. An apparatus according to claim 35, characterized in that the at least one memory and the computer program code are configured to, with the at least one processor, cause the apparatus to
run radio access network application protocol signalling between the apparatus and the associated macro network node over IPSec by using a security association between the associated macro network node and the apparatus.

41. An apparatus according to claim 35, characterized in that the at least one memory and the computer program code are configured to, with the at least one processor, cause the apparatus to
relay ciphered signalling messages from the user terminal (804) to the macro network apparatus via a local network interface by using secured tunnelling.
